(19) United States
(12) Patent Application Publication
(10) Pub. No.: US 2008/0034535 A1
(43) Pub. Date: Feb. 14, 2008

(54) Door closer

(76) Inventor: Chi-Tsao Chiang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/489,495

(22) Filed: Jul. 20, 2006

(51) Int. Cl. E05F 3/00

(52) U.S. Cl. 16/60

(57) ABSTRACT

A door closer includes a casing having a hydraulic cylinder in which a coupling block is received, and a first tunnel and a second tunnel are in communication with the hydraulic cylinder. A passage is in communication between the first and second tunnels so as to allow the hydraulic oil to flow between the two tunnels. The coupling block includes a pivot shaft for being connected to a door. A first rod and a second rod are pivotably connected to the coupling block and respectively inserted in the first and second tunnels. A threaded rod is connected to a distal end of the first rod and a first spring is mounted to the first rod and the threaded rod. A sleeve is threadedly engaged with the threaded rod and an operation rod is securely connected to the sleeve so that when rotating the operation rod, the first spring is adjusted by moving the sleeve relative to the threaded rod.

### FIELD OF THE INVENTION

The present invention relates to a door closer, and more particularly to such a door closer, which comprises a double-treaded adjustment rod controlled to regulate the spring power of the compression springs of the reciprocating mechanism thereof in adjusting the return speed of the door.

### BACKGROUND OF THE INVENTION

A conventional door closer known is disclosed in U.S. Pat. No. 6,493,904 which includes two cylinders in a casing and two pistons are respectively and movably received in the cylinders. The two pistons are biased by two springs and a baffle contacts two respective ends of the two springs. An adjustment block is fixed connected to the baffle and a first end of an adjustment rod is connected to the block. A second end of the adjustment rod can be operated by the user so as to compress both of the springs to adjust the restoration forces of the two springs. In other words, although there are two springs in the closer, they cannot be adjusted individually. This limits the number of functions that the springs may have. Another conventional door closer is disclosed in U.S. Pat. No. 5,829,097 and includes two springs which are able to be adjusted by rotating a knob located at an end of the closer. However, the knob is located between a side of the door and the doorframe, and only very limited space allows the user to access the knob. Besides, the door closer includes a complicated structure that increases the manufacturing cost and the time of assembly. Yet another conventional door closer is disclosed in U.S. Pat. No. 5,802,670 which includes only one spring and the only one spring is compressed by a movable adjusting sleeve with a cam plate. The only one spring obviously performs only one function which makes the door to be opened and closed at the same speed.

The present invention intends to provide a door closer that includes two springs and only one of which is adjusted so that the two springs play different roles during operation of the door closer.

### SUMMARY OF THE INVENTION

In accordance with one aspect of the present invention, there is provided a door closer which comprises a casing having a hydraulic cylinder and a first tunnel and a second tunnel are in communication with the hydraulic cylinder. A passage is in communication between the first and second tunnels so that hydraulic oil may flow between the two tunnels.

A coupling block is received in the hydraulic cylinder and has a pivot shaft to be connected to a door. A first rod and a second rod are pivotably connected to the coupling block and respectively inserted in the first and second tunnels. A threaded rod is connected to a distal end of the first rod and a first spring is mounted to the first rod and the threaded rod. A sleeve has a threaded inner periphery which is engaged with the threaded rod. An operation rod is securely connected to the sleeve and an end member is rotatably connected to the operation rod and seals the first tunnel. A second spring is mounted to the second rod and a piston is connected to a distal end of the second rod. An end piece seals the second tunnel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the door closer of the present invention;

FIG. 2 is a cross sectional view to show the door closer of the present invention;

FIG. 3 is a cross sectional view to show the first rod in the door closer of the present invention,

FIG. 4 is a exploded view to show the first rod, the threaded rod, the sleeve, and the operation rod of the door closer of the present invention, and;

FIG. 5 shows two valves which control the volume of hydraulic oil through the passage.

### DETAILED DESCRIPTION OF THE PREFERRED EMBODIMENT

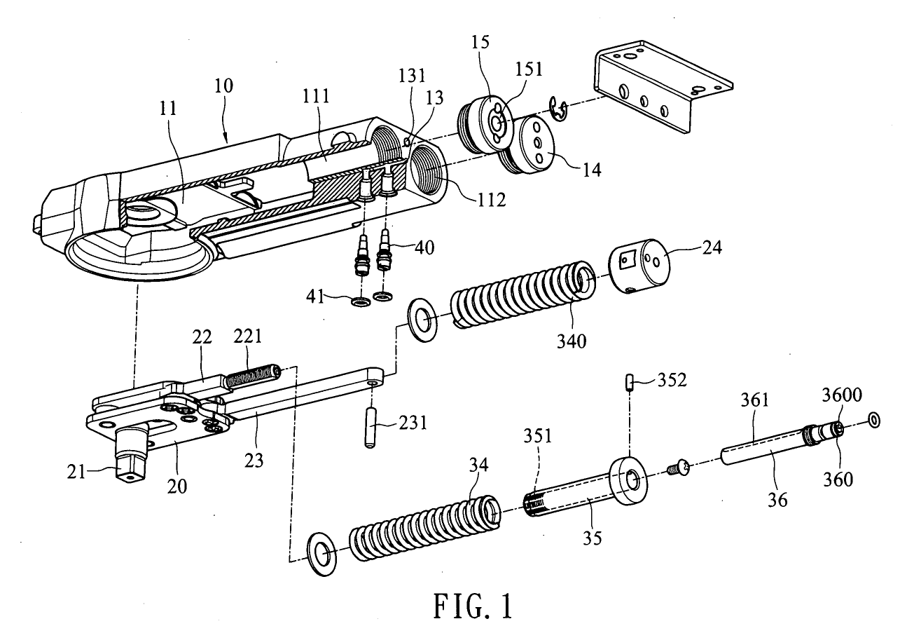

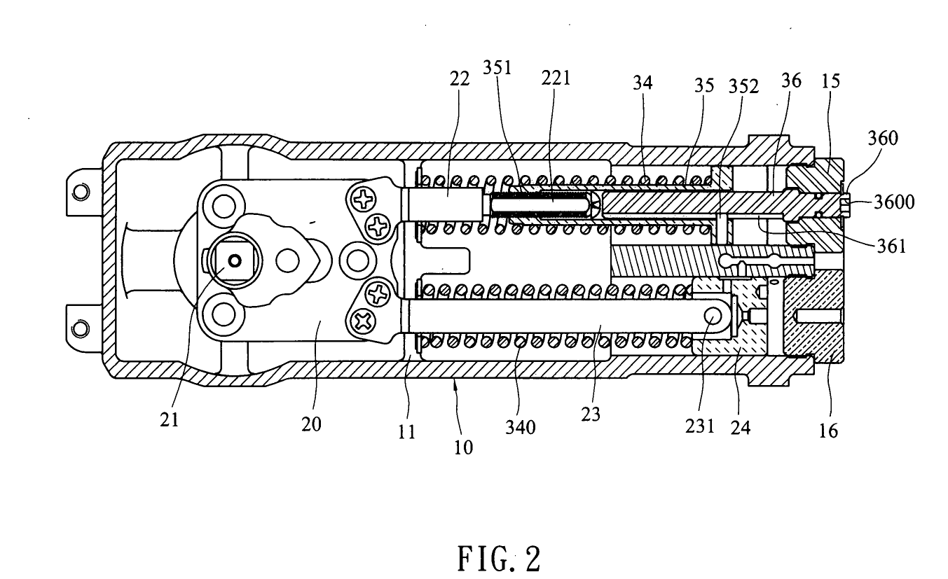

Referring to FIGS. 1 and 2, the door closer of the present invention comprises a casing 10 having a hydraulic cylinder 11 defined therein so that a coupling block 20 is received in the hydraulic cylinder 11 and located at a first end of the casing 10. A first tunnel 111 and a second tunnel 112 are in communication with the hydraulic cylinder 11. A first passage 13 and a second passage 131 are defined in the casing 10.

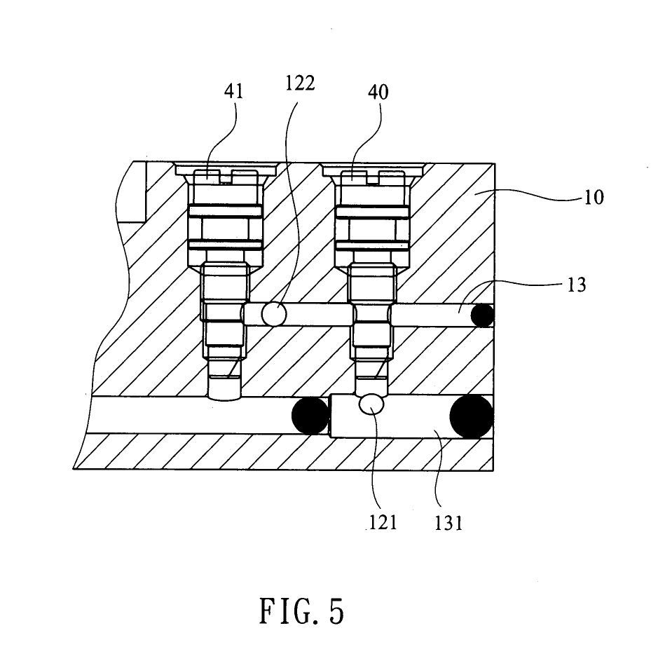

Further referring to FIG. 5, A first sub-passage 122 is defined in communication with the first passage 13, and a second sub-passage 121 is defined in communication with the second passage 131, so that the hydraulic oil may flow into the two tunnels 111, 112 during the operation of the closer two fluid velocity regulating valves 40 are engaged with two respective washer 41 transversely defined in the casing 10 and respectively communicating with the first passage 13 and the first sub-passage 122, and the second passage 131 and the second sub-passage 121. The fluid velocity regulating valves 40 control the volume of the hydraulic oil, which enters into the two tunnels 111 and 112.

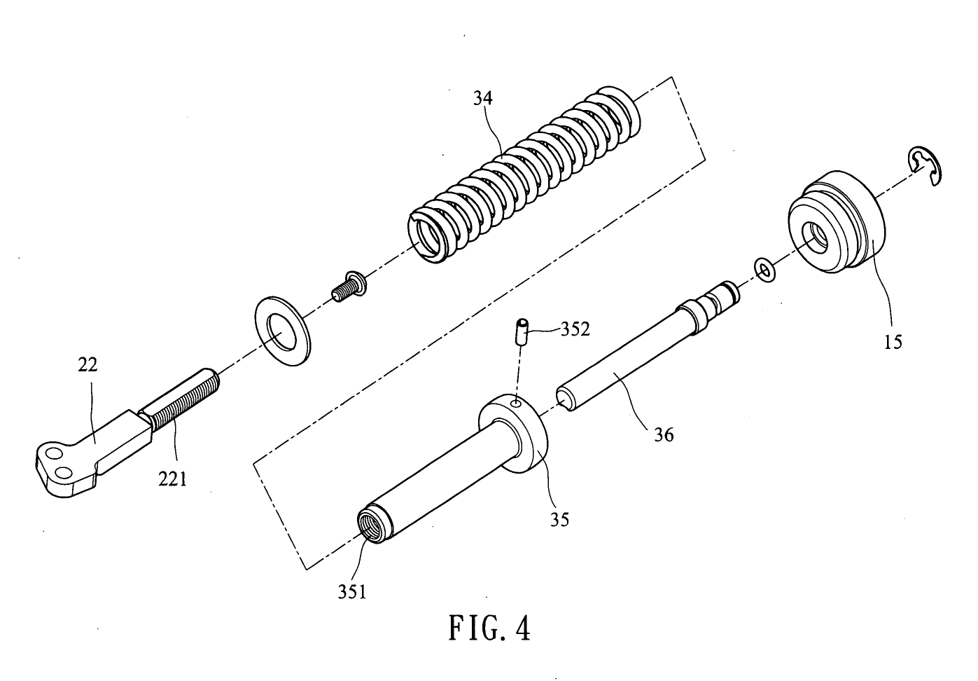

Referring to FIGS. 1 to 4,The coupling block 20 includes a pivot shaft 21 extending therefrom so as to be connected to a door which is not shown. A first rod 22 and a second rod 23 are pivot ably connected to the coupling block 20 and respectively inserted in the first and second tunnels 111, 112. A threaded rod 221 is connected to a distal end of the first rod 22 and a first spring 34 is mounted to the first rod 22 and the threaded rod 221. A sleeve 35 has a threaded inner periphery 351 and the threaded rod 221 is threadedly engaged with the threaded inner periphery 351 of the sleeve 35. The sleeve 35 has a flange such that the first spring 34 is biased between a shoulder portion of the first rod 22 and the flange of the sleeve 35. An operation rod 36 has an end thereof rotatably engaged with a hole 151 defined through an end member 15 which seals the first tunnel 111. A knob 360 extends from the end of the operation rod 36 and a polygonal hydraulic cylinder 3600 is defined in the knob 360 so that a tool can be used to rotate the operation rod 36 by engaging the polygonal hydraulic cylinder 3600. The knob 360 is located at a second end of the casing 10 so as to be easily accessed by the users. The operation rod 36 has at least one longitudinal groove 361 defined in an outer periphery thereof and a boss 352 extends from an inner periphery of the sleeve 35 so that the boss 352 is engaged with the groove 361. By the engagement, when the operation rod 36 is rotated, the sleeve 35 is rotated relative to the threaded rod 351 and the first spring 34 is compressed by the movement of the sleeve 35.

A second spring 340 is mounted to the second rod 23 and a piston 24 is connected to a distal end of the second rod 23. An screw caps 14 seals the second tunnel 112.

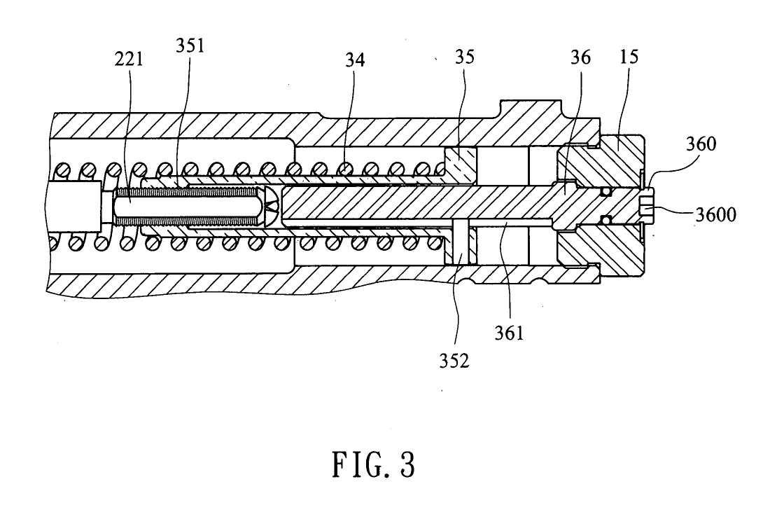

As shown in FIG. 2 and 3, when rotating the operation rod 36, the sleeve 35 moves along the threaded rod 221 so that the first spring 34 is can be adjusted. The knob 360 is located at an end of the casing 10 and opposite to the pivot shaft 21 so that the user is easily to operate the operation rod 36.

While we have shown and described the embodiment in accordance with the present invention, it should be clear to those skilled in the art that further embodiments may be made without departing from the scope of the present invention.

What is claimed is:

1. A door closer comprising:
a casing having a hydraulic cylinder defined therein and a first tunnel and a second tunnel being in communication with the hydraulic cylinder, a passage being in communication between the first and-second tunnels, and
a coupling block received in the hydraulic cylinder and located close to a first end of the casing, the coupling block including a pivot shaft extending therefrom, the pivot shaft adapted to be connected to a door, a first rod and a second rod pivotably connected to the coupling block and respectively inserted in the first and second tunnels, a threaded rod connected to a distal end of the first rod and a first spring mounted to the first rod and the threaded rod, a sleeve having a threaded inner periphery and the threaded rod threadedly engaged with the threaded inner periphery of the sleeve, an operation rod having a first end securely connected to the sleeve and an end member rotatably connected to a second end of the operation rod and sealing the first tunnel, the second end of the operation rod located at a second end of the casing, a second spring mounted to the second rod and a piston connected to a distal end of the second rod, an end piece sealing the second tunnel.

2. The door closer as claimed in claim 1, wherein the operation rod has at least one longitudinal groove defined in an outer periphery thereof and a boss extends from an inner periphery of the sleeve, the boss engaged with the groove.

3. The door closer as claimed in claim 1, wherein the end member includes a hole defined therethrough and the second end of the operation rod is engaged with the hole, a polygonal hydraulic cylinder defined in the end of the operation rod.
